(19) United States
(12) Patent Application Publication
(10) Pub. No.: US 2020/0258074 A1
(43) Pub. Date: Aug. 13, 2020

(54) SYSTEM AND METHOD FOR IMPLEMENTING VEHICLE-BASED PAYMENT TOKENIZATION

(71) Applicant: JPMORGAN CHASE BANK, N.A., New York, NY (US)

(72) Inventors: Eric Han Kai CHANG, Wilmington, DE (US); James P. WHITE, III, Middletown, DE (US); Noor SHADID, Wilmington, DE (US); John L. OLIVER, III, Smyrna, DE (US); Erin Michelle PERRY, Townsend, DE (US); Daniel D. MCQUISTON, West Chester, PA (US); Saifuddin MERCHANT, Claymont, DE (US)

(21) Appl. No.: 16/783,642

(22) Filed: Feb. 6, 2020

Related U.S. Application Data
(60) Provisional application No. 62/804,401, filed on Feb. 12, 2019.

(51) Int. Cl. G06Q 20/32; G06Q 20/42; G06Q 20/08

(52) U.S. Cl. CPC G06Q 20/3223; G06Q 20/0855; G06Q 20/42

(57) ABSTRACT

Systems and methods for implementing vehicle-based payments are disclosed. In one embodiment, in a vehicle-based payment system comprising a payment integration unit that is connected to a mobile electronic device, a method for vehicle-based payments may include: (1) the payment integration unit receiving a confirmation request for a vehicle-based transaction from a third-party; (2) the payment integration unit receiving confirmation of the vehicle-based transaction from a vehicle user; (3) the payment integration unit communicating a payment token request from a financial institution backend to the mobile electronic device, wherein the mobile electronic device communicates the payment token request to the financial institution and receives a payment token from the financial institution; (3) the payment integration unit receiving the payment token from the mobile electronic device; and (4) the payment integration unit communicating the payment token to the third party, wherein the third party conducts the transaction using the payment token.

### RELATED APPLICATIONS

This application claims the benefit of, and priority to, U.S. Provisional Patent Application Ser. No. 62/804,401, filed Feb. 12, 2019, the disclosure of which is hereby incorporated, by reference, in its entirety.

### BACKGROUND OF THE INVENTION

### 1. Field of the Invention

Embodiments relate generally to systems and methods for implementing vehicle-based payment tokenization.

### 2. Description of the Related Art

Generally, paying for services while in a vehicle requires the driver or passenger to physically interact with a vendor or merchant to complete a transaction. This leads to slow transaction times, reliance on physical objects (e.g., a card reader, a physical card, etc.), and often requires that the financial instrument be on hand.

### SUMMARY OF THE INVENTION

Systems and methods for implementing vehicle-based payment tokenization are disclosed. In one embodiment, in a vehicle-based payment system comprising a payment integration unit that is connected to a mobile electronic device, a method for vehicle-based payments may include: (1) the payment integration unit receiving a confirmation request for a vehicle-based transaction from a third-party; (2) the payment integration unit receiving confirmation of the vehicle-based transaction from a vehicle user; (3) the payment integration unit communicating a payment token request from a financial institution backend to the mobile electronic device, wherein the mobile electronic device communicates the payment token request to the financial institution and receives a payment token from the financial institution; (3) the payment integration unit receiving the payment token from the mobile electronic device; and (4) the payment integration unit communicating the payment token to the third party, wherein the third party conducts the transaction using the payment token.

In one embodiment, the third party may include a merchant. The third party may provide a vehicle service such as a parking service, a toll service, a maintenance service, etc.

In one embodiment, the payment integration unit may be paired with the mobile electronic device.

In one embodiment, the method may further include the payment integration unit receiving a transaction receipt from the merchant.

In one embodiment, the method may further include the payment integration unit identifying the third party based on a location of the vehicle.

In one embodiment, the method may further include the payment integration unit identifying the third party based on a communication received from the third party.

In one embodiment, the method may further include the payment integration unit identifying the third party based on an operating mode for the vehicle.

In one embodiment, the method may further include the payment integration unit receiving vehicle user authenticating information from at least one vehicle sensor; and the payment integration unit authenticating the vehicle user with the vehicle user authenticating information.

In one embodiment, the method may further include the payment integration unit receiving vehicle user authenticating information from the mobile electronic device; the payment integration unit receiving vehicle user authenticating information from at least one vehicle sensor; and the payment integration unit authenticating the vehicle user with the vehicle user authenticating information from the mobile electronic device and the vehicle user authenticating information from at least one vehicle sensor.

According to another embodiment, a system for vehicle-based payments may include a vehicle comprising a payment integration unit and a vehicle user interface; a mobile electronic device in communication with the mobile electronic device; and a financial institution. The payment integration unit may receive a confirmation request for a vehicle-based transaction from a third-party, and may receive confirmation of the vehicle-based transaction from the vehicle user interface. The payment integration unit may communicate a payment token request from the financial institution backend to the mobile electronic device, and the mobile electronic device may communicate the payment token request to the financial institution. The financial institution may provide a payment token to the mobile electronic device, the mobile electronic device may provide the payment token to the payment integration unit, and the payment integration unit may communicate the payment token to the third party. The third party may conduct the transaction using the payment token.

In one embodiment, the third party may include a merchant. The third party may provide a vehicle service such as a parking service, a toll service, a maintenance service, etc.

In one embodiment, the payment integration unit may be paired with the mobile electronic device.

In one embodiment, the payment integration unit may receive a transaction receipt from the merchant.

In one embodiment, the payment integration unit may include a tracking module that identifies potential third-party transaction partners. The tracking module may identify potential third-party transaction partners based on a location of the vehicle.

In one embodiment, the payment integration unit may include an operating module that may identify an operating mode of the vehicle.

In one embodiment, the payment integration unit may include an authentication module that may receive vehicle user authenticating information from at least one vehicle sensor and may authenticate the vehicle user with the vehicle user authenticating information. The authentication module may also receive vehicle user authenticating information from at least one vehicle sensor and vehicle user authenticating information from the mobile electronic device, and may authenticates the vehicle user with the vehicle user authenticating information from the mobile electronic device and the vehicle user authenticating information from at least one vehicle sensor.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for implementing vehicle-based payment tokenization according to one embodiment;

FIG. 2 depicts a method for implementing vehicle-based payment tokenization according to one embodiment.

### DETAILED DESCRIPTION OF PREFERRED EMBODIMENTS

Embodiments are directed to systems and methods for implementing vehicle-based payment tokenization.

Embodiments may include an interface unit that may be integrated with a vehicle for implementing vehicle-based payment tokenization. The interface unit may include an electronic input in communication with a mobile device (e.g., smart phone, smart watch, smart ring, smart glasses, IoT devices, etc.) and a computer processor, coupled to the electronic input and a memory component. The interface unit may initiate a pairing process between the vehicle and the mobile device; receive a request for a transaction; communicate with a merchant associated with the transaction; confirm the transaction with the merchant; request a payment token from a digital payment service for the transaction; effectuate the transaction with the payment token; and receive an acknowledgement.

Embodiments may provide improved transaction processing while a user is in a vehicle, and may provide benefits and advantages for customers, financial institutions, and merchants, such as merchants that support drive-through transactions, parking garages, toll plazas, parking meters, slips, marinas, airports, etc. Embodiments may provide security and safety for the user because the user may not need to leave the vehicle to conduct a transaction.

In embodiments, the vehicle or other device may be paired to, or synchronized with, a mobile device (e.g., a smart phone, computer, etc.) that may be associated with the user. This further leverages the mobile device's smart payment system, such as a digital wallet, that enables a user to make transactions and/or purchases with the vehicle acting as an extension of the mobile device.

Other intelligent wearable devices, such as smart watches, next generation devices (IoT devices, implants, etc.) may be used as is necessary and/or desired.

in embodiments, a user may conduct transactions from a vehicle by providing a voice or gesture input, by interacting, for example, with an input on a steering wheel by providing a gesture (e.g., a tap, a double tap, a biometric (e.g., a fingerprint, a gesture, pressure, etc.), etc. The user may further provide an input to a sensor by, for example, tapping a sensor with a NFC-enabled device, such as a smart watch. Embodiments may use a smart steering wheel to detect a user's input. In addition, a physical input (e.g., a button, switch, etc.) may be available through the steering wheel, console, unit or other input to auto-enable, confirm and/or approve transactions.

The user may also provide a biometric (e.g., voice, fingerprint, facial feature, etc.) for authentication. In one embodiment, an image of the user's face may be captured by an image capture device within the vehicle, such as within the vehicle's rear-view mirror.

An embodiment of the present invention may receive and/or generate notifications and proxy confirmations. For example, the user may receive a device notification that. confirms a current transaction, e.g., “you just spent $30 on Bob's gas station.” The system may also provide warnings when charges are about to take place. This may occur through the use of beacons or other similar technology. In addition, notifications may be presented to the user via haptic feedback on the steering wheel (e.g., vibrations, movements, etc.). Other variations may be implemented.

In embodiments, a hardware unit may be integrated with a vehicle. The hardware unit may also leverage existing technology in the vehicle, such as a power source, radio antennas, wireless technology, communication mechanisms, etc.

In embodiments, an external sensor array may be provided for a vehicle. For example, the external sensor array may be associated with a vehicle's internal computer as well as wiring harness for power, data, etc. In addition, the external sensor array may provide various features and functions, such as detecting payment capabilities and communicating with vendors as well as other devices. For example, the external sensor array may be affixed to a windshield, bumper, or may be integrated with an existing vehicle radio antenna.

In embodiments, an internal sensor array may be provided for a vehicle. For example, the internal sensor array may detect and confirm approvals and/or rejections of transactions, communicate with a user's device, provide haptic feedback wheel, implement biometrics (e.g., fingerprint scanner, facial recognition), support gestures (e.g., tap wheel, wave hand, etc.), and various other inputs or outputs as is necessary and/or desired.

In embodiments, various payment mechanisms may be used. For example, a transaction may be conducted using a digital wallet application or service. As another example, the user may manually enter payment information into a vehicle's computer or other input.

Embodiments may support various use cases and applications. For example, during the course of a day, a user may perform a series of transactions, including renting a car, getting food, paying tolls, driving to a hotel, paying for hotel parking, etc. In this example, the user may pair a mobile device with a vehicle (e.g., rental car) to enable the vehicle to make transactions, payments, etc. for the user. The user may stop by a drive-thru restaurant and place an order, and may be prompted for a payment. The vehicle may confirm the transaction via audio notification, visual notification (e.g., on screen, on a head's up display, etc.), by device notification, haptic feedback, etc. In response, the user may provide a confirmation via audio, gesture, haptic, face, fingerprint, etc. Embodiments may provide various benefits, including eliminating the need to drive up to a payment window. The system further provides contactless payment, expedites turnaround and minimizes queueing.

In embodiments, a merchant may create a new transaction and then push transaction details to an external-reader that may be integrated with the vehicle. The reader may display details and confirm transactions with a user via an onboard software (e.g., GoogleAuto, Apple CarPlay, Ford Sync, etc.). Embodiments may differentiate between various types of transactions (e.g., tolls versus retail, etc.). Transaction confirmation may be performed by the user via fingerprint, gesture, voice recognition, multifactor authentication (MFA), etc.

Embodiments may support active and passive communications. With an embodiment of the present invention, merchants may support active workflows as well as passive workflows for various transactions. The system may also support proxied and embedded transactions.

Embodiments may support various transactions, including parking meters, drive through merchants, parking garages, etc. The system may also support recurring payments, such as monthly parking fees, etc.

Payments may be made to handheld. payment devices, _{QR} code reading devices, or maybe integrated with a service provider (e.g., with a parking facility or mobile application). In one embodiment, the payment method may be set by default, may be automatically selected to optimize a benefit to the user (e.g., reward points, discounts, interest, float, minimize balances, etc.), may be manually selected, etc.

In one embodiment, other entities, such as third-party merchants, goods and service providers, individuals, etc. may request payment from a vehicle. For example, a law enforcement officer may request payment for fines such as speeding, parking, etc., with all relevant details and metadata attached to the transaction. This may be performed asynchronously by the officer, and the driver may pay immediately.

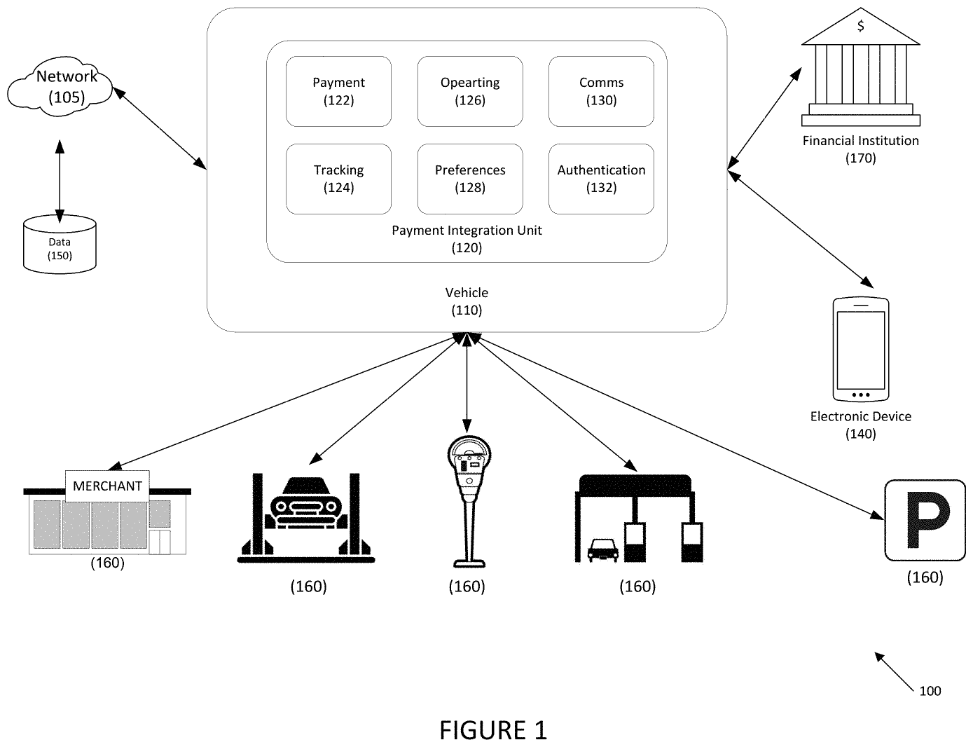

Referring to FIG. 1, an exemplary system for implementing a vehicle-based payment is disclosed according to embodiments. System 100 may include vehicle 110, which may include any suitable vehicle. Although embodiments may be discussed in the context of an automobile, it should be recognized that any sort of vehicle, including automobiles, rental vehicles, busses, motorcycles, trucks, boats, watercraft, aircraft, spacecraft, scooters, bicycles, etc. may be used as is necessary and/or desired.

Vehicle 110 may include payment integration unit 120. Payment integration unit 120 may be provided as part of vehicle 110, or it may be added as an after-market addition. In embodiments, payment integration unit 120 may integrate with vehicle's 110 control systems, entertainment systems, etc.

Payment integration unit 120 may include one or more module or component, such as payment module 122, tracking module 124, operating module 126, preferences module 128, communications (comms) module 130, and authentication module 132. Additional, fewer, or different modules may be provided as is necessary and/or desired. Although a single illustrative block may be used to depict a module or component, it should be recognized that a module or component may include multiple units, devices, etc. In addition, the modules or components may be combined into a consolidated unit, may share resources, etc. The modules and/or components may be further duplicated, combined and/or separated across multiple systems at local and/or remote locations. Other architectures may be realized.

Payment module 122 may enable transactions with merchants, vendors, service providers, entities, etc. Transactions may be made using a digital wallet or other payment mechanisms that may be separate from or part of vehicle 110. Transactions may include meal purchases, toll payments, parking garage fees, vehicle service fees, vehicle-to-person payments, etc. Embodiments may also apply payment preferences that may include using a particular payment instrument for certain types of transactions.

Tracking module 124 may support sensors and other technology to identify when vehicle 110 is likely to conduct a transaction. For example, tracking module 124 may identify potential transaction partners, such as parking meters, tolls, parking garages, service facilities, etc. Tracking module 124 may also manage geolocation and other location data. Embodiments may support targeted messaging, including advertisements, offers, etc., based on vehicle 110's location, operation mode, and/or other information.

Operating module 126 may identify various operating modes (e.g., driving mode, parking mode, off mode, etc.) so that the system may recognize when certain actions are expected. For example, when vehicle 110 is in driving mode, the system may refrain from recognizing nearby parking meters. In parking mode, the system may assist in finding a parking spot in a garage or lot and further remember where the vehicle is located.

Preferences module 128 may implement a user's settings, priorities, etc. For example, multiple drivers may use a family car. Depending on the driver, a set of preferences may be applied. In addition, a parent may place a limit on spend and/or type of transactions when a teenager is driving the family car. For example, a parent may require biometric approval for certain transactions outside a geofence and/or other restriction.

An embodiment may also support carpooling and split transactions. For example, a group of people may commute together. In this scenario, the daily, weekly and/or even monthly expenses may be split and shared. The expenses may include tolls, gas, etc. A similar feature may be applied to a group of people taking a road trip together. Exemplary details are disclosed in U.S. patent application Ser. No. 15/193,492, filed Jun. 27, 2016, the disclosure of which is hereby incorporated, by reference, in its entirety.

Communication module 130 may support two-way communications with third parties 160, such as merchants, parking meters, parking garages, toll providers, individuals, etc. Communication module 130 may also support targeted advertisements from third parties 160 and/or other sources.

Embodiments may leverage a token (not shown) to validate vehicle 110 so that the token may be used as a security token. For example, third party 160 (e.g., a parking garage), may recognize vehicle 110 based on it security token.

Authentication module 132 may support authorization and/or authentication functionality. For example, authentication module 132 may provide confirmation for purchases and/or other transactions. In addition, vehicle 110 and/or electronic device 140 may support authentication using biometric and other input devices, such as a fingerprint reader, a camera for facial recognition, a microphone, a keypad, a touch pad, a touch screen, etc.

Mobile electronic device 140 may be associated with a user of vehicle 110, such as a driver, passenger, owner, etc. Mobile electronic device 140 may be communicatively coupled (e.g., linked or paired) with payment integration unit 120 to form a consolidated interface in any suitable manner (e.g., wired, wireless, etc.). Other architectures and formations may be used as is necessary and/or desired.

The interface formed by the coupling of payment integration unit 120 and electronic device 140 may communicate with one or more third parties 160 to conduct a transaction.

The interface formed by the coupling of payment integration unit 120 and electronic device 140 may store data in various storage components, represented by database 150. One or more database 150 may be provided. Database 150 may store data in any suitable data structure to maintain the information and allow access and retrieval of the information. For example, the storage components may keep the data in an organized fashion and may be an Oracle database, a Microsoft SQL Server database, a DB2 database, a MySQL database, a Sybase database, an object-oriented database, a hierarchical database, a flat database, and/or another type of database as may be known in the art to store and organize data as described herein. The storage may be local, remote, or a combination. The storage components may have back-up capability built-in. Communications with the storage components may be over a network, such as network 105, or communications may involve a direct connection with database 150. Database 150 may further provide cloud or other network based storage.

System 100 may be implemented as hardware components (e.g., module) within one or more network elements, as computer executable software (e.g., on a tangible, non-transitory computer-readable medium) located within one or more network elements, etc. Module functionality of architecture within system 100 may be located on a single device or distributed across a plurality of devices including one or more centralized servers and one or more mobile units or end user devices. The architecture depicted in system 100 is meant to be exemplary and non-limiting. For example, while connections and relationships between the elements of system 100 is depicted, it should be appreciated that other connections and relationships are possible. The system 100 described below may be used to implement the various methods herein, by way of example. Various elements of the system 100 may be referenced in explaining the exemplary methods described herein.

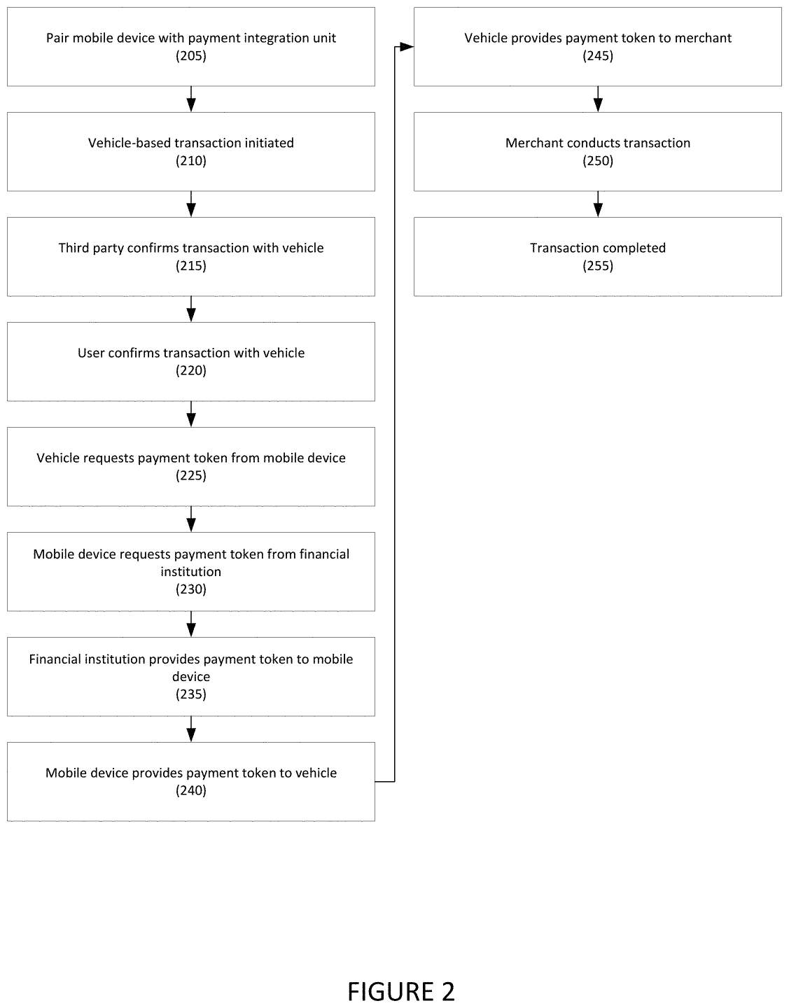

FIG. 2 depicts an exemplary method for conducting vehicle-based payment according to an embodiment.

In step 205, a user may communicatively couple a mobile electronic device with a payment integration unit for a vehicle. For example, the mobile device and the payment integration unit may be paired, linked, etc. wirelessly or by wires. In one embodiment, the payment integration unit may be original equipment within the vehicle; in another embodiment, the payment integration unit may be an after-market addition.

In one embodiment, the payment integration unit may provide access to one or more vehicle systems, including power, antennas, input/output, sensors, GPS, display screens, etc.

Once communicatively coupled, the mobile device and the payment integration unit may communicate with each other, and may share resources (e.g., the mobile device may use the input/output of the vehicle via the payment integration unit.

In step 210, a vehicle-based transaction with a third party may be initiated. In one embodiment, one or more sensor or interface in the vehicle may identify a potential transaction based, for example, on one or more of a vehicle operating mode (e.g., driving mode, parking mode, off mode, etc.), a vehicle location (e.g., in a parking lot, on a highway, etc.), a communication received (e.g., a signal from a beacon, RF interrogation, a payment request from a third party, etc.), past user activities (e.g., patterns), user initiation of the transaction, etc.

In step 215, the third party may confirm a transaction request with the vehicle. In one embodiment, this confirmation may be part of the initiation in step 210. In another embodiment, the third party may communicate a separate request identifying the transaction (e.g., transaction type, transaction amount, etc.)

In one embodiment, the third party may send the confirmation in response to the user or vehicle initiating the transaction. The vehicle may receive the confirmation request and may present it to the user on a vehicle system (e.g., displayed on a display, announced via a speaker), on the user's mobile device, etc.

In step 220, the user may confirm the transaction with the vehicle. For example, the user may indicate approval or disapproval in any suitable manner using a vehicle system, the mobile device, etc.

In step 225, the vehicle may request a payment token for the transaction from the mobile device. In one embodiment, the vehicle may communicate the request to the mobile device directly without involvement from the user.

In one embodiment, the vehicle may authenticate the user before requesting the payment token. In one embodiment, the vehicle may use a vehicle system (e.g., biometric sensor, camera, microphone, input, etc.) and/or the mobile electronic device (e.g., biometric sensor, camera, microphone, input, etc.) to receive authenticating information and authenticate the user.

In step 230, the mobile device may request a payment token from a financial institution, such as an issue of a financial instrument. In one embodiment, the mobile device and/or the vehicle may use a user preference to identify the financial instrument on which to base the payment token request. For example, if the transaction is with a certain merchant, the vehicle may request a payment token for a specific financial instrument that may provide greater rewards with the merchant.

In one embodiment, the mobile device may communicate the user preferences with the payment token request and the financial institution backend may apply the rules. In another embodiment, the financial institution backend may have the user's preferences stored therewith, or may have access to the user's preferences, and may identify the payment token to provide.

In step 235, the financial institution may provide the payment token to the mobile device, and, in step 240, the mobile device may provide the payment token to the vehicle. In one embodiment, the mobile device may provide the payment token to the vehicle without any user involvement.

In step 245, the mobile device may provide the payment token to the merchant, and in step 250, the merchant may conduct the transaction.

In step 255, the transaction may be complete. The merchant may issue a receipt, an acknowledgement, etc. to the mobile device via the vehicle.

Although several embodiments have been disclosed, it should be recognized that these embodiments are not exclusive to each other, and certain elements or features from one embodiment may be used with another.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for vehicle-based payments, comprising:
in a vehicle-based payment system comprising a payment integration unit that is connected to a mobile electronic device:
the payment integration unit receiving a confirmation request for a vehicle-based transaction from a third-party;
the payment integration unit receiving confirmation of the vehicle-based transaction from a vehicle user;
the payment integration unit communicating a payment token request from a financial institution backend to the mobile electronic device, wherein the mobile electronic device communicates the payment token request to the financial institution and receives a payment token from the financial institution;
the payment integration unit receiving the payment token from the mobile electronic device; and
the payment integration unit communicating the payment token to the third party, wherein the third party conducts the transaction using the payment token.

2. The method of claim 1, wherein the third party comprises a merchant.

3. The method of claim 1, wherein the third party provides a vehicle service comprising at least one of a parking service, a toll service, and a maintenance service.

4. The method of claim 1, wherein the payment integration unit is paired with the mobile electronic device.

5. The method of claim 1, further comprising:
the payment integration unit receiving a transaction receipt from the merchant.

6. The method of claim 1, further comprising:
the payment integration unit identifying the third party based on a location of the vehicle.

7. The method of claim 1, further comprising:
the payment integration unit identifying the third party based on a communication received from the third party.

8. The method of claim 1, further comprising:
the payment integration unit identifying the third party based on an operating mode for the vehicle.

9. The method of claim 1, further comprising:
the payment integration unit receiving vehicle user authenticating information from at least one vehicle sensor; and
the payment integration unit authenticating the vehicle user with the vehicle user authenticating information.

10. The method of claim 1, further comprising:
the payment integration unit receiving vehicle user authenticating information from the mobile electronic device;
the payment integration unit receiving vehicle user authenticating information from at least one vehicle sensor; and
the payment integration unit authenticating the vehicle user with the vehicle user authenticating information from the mobile electronic device and the vehicle user authenticating information from at least one vehicle sensor.

11. A system for vehicle-based payments, comprising:
a vehicle comprising a payment integration unit and a vehicle user interface;
a mobile electronic device in communication with the mobile electronic device; and
a financial institution; and
wherein:
the payment integration unit receives a confirmation request for a vehicle-based transaction from a third-party;
the payment integration unit receives confirmation of the vehicle-based transaction from the vehicle user interface;
the payment integration unit communicates a payment token request from the financial institution backend to the mobile electronic device;
the mobile electronic device communicates the payment token request to the financial institution;
the financial institution provides a payment token to the mobile electronic device;
the mobile electronic device provides the payment token to the payment integration unit; and
the payment integration unit communicates the payment token to the third party, wherein the third party conducts the transaction using the payment token.

12. The system of claim 11, wherein the third party comprises a merchant.

13. The system of claim 11, wherein the third party provides a vehicle service comprising at least one of a parking service, a toll service, and a maintenance service.

14. The system of claim 11, wherein the payment integration unit is paired with the mobile electronic device.

15. The system of claim 11, wherein the payment integration unit receives a transaction receipt from the merchant.

16. The system of claim 11, wherein the payment integration unit comprises a tracking module that identifies potential third-party transaction partners.

17. The system of claim 16, wherein the tracking module identifies potential third-party transaction partners based on a location of the vehicle.

18. The system of claim 11, wherein the vehicle integration until comprises an operating module that identifies an operating mode of the vehicle.

19. The system of claim 11, wherein the vehicle integration unit comprises an authentication module that receives vehicle user authenticating information from at least one vehicle sensor and authenticates the vehicle user with the vehicle user authenticating information.

20. The system of claim 11, wherein the vehicle integration unit comprises an authentication module that receives vehicle user authenticating information from at least one vehicle sensor and vehicle user authenticating information from the mobile electronic device, and authenticates the vehicle user with the vehicle user authenticating information from the mobile electronic device and the vehicle user authenticating information from at least one vehicle sensor.
